(19) United States
(12) Patent Application Publication
(10) Pub. No.: US 2015/0307032 A1
(43) Pub. Date: Oct. 29, 2015

(54) EMBLEM CARRIER

(71) Applicant: Ulbrichts Witwe GmbH, Schwanenstadt (AT)

(72) Inventors: Daniel BECKSTEINER, Kirchham (AT); Georg SCHARPENACK, Altmuenster (AT)

(21) Appl. No.: 14/694,380

(22) Filed: Apr. 23, 2015

(30) Foreign Application Priority Data
Apr. 25, 2014 (AT) 299/2014

(51) Int. Cl. B60R 13/00

(52) U.S. Cl. CPC B60R 13/005

(57) ABSTRACT

An emblem carrier comprising a base plate by way of which the emblem carrier can be fixed to a supporting surface, and a presentation body which is in the form of an emblem or which serves for the arrangement of an emblem, wherein the presentation body and the base plate are fixed together by a clipping engagement, which has a multiplicity of hooks and a plurality of openings, wherein in the clipped condition a hook projects into an opening and a head portion of said hook engages behind the opening, wherein there is provided a resilient limb portion which partially covers the opening and which moves out of the way of the head portion of the hook when the hook is introduced into the opening.

The invention concerns an emblem carrier having the features of the classifying portion of claim 1.

A problem with the state of the art is that, when the hooks are introduced into the openings, the head portion of one or more hooks is frequently sheared off whereby it is no longer possible to achieve secure clipping engagement between the base plate and the presentation body.

That problem occurs in particular—but not just—when using polymethylmethacrylate (PMMA) as the material for the base plate as PMMA is hard and brittle.

The object of the invention is to provide an emblem carrier of the general kind set forth, in which that problem does not arise.

That object is attained by an emblem carrier having the features of claim 1.

Advantageous embodiments of the invention are defined in the appendant claims.

The term ‘emblems’ is used to denote in particular images, logos, corporate brand names or marks or trade marks, alphanumeric characters or character combinations, or codes.

By virtue of the resilient limb portion which is preferably tongue-shaped and which is preferably arranged on the base plate and which partially covers over the opening radially from one side of the periphery of the opening, the free region of the opening can be increased upon introduction of the head portion of the hook, by virtue of a deflection movement of the limb portion into the depthwise extent of the opening, that is to say in the direction of a rear side of the base plate, so that the head portion of the hook is prevented from being sheared off even when using a very hard and brittle material for the base plate. On the other hand, after the head portion of the hook has been introduced, the free region of the opening is sufficiently small, by virtue of the limb portion being at least partially moved back into its starting position again, that the hook is reliably prevented from moving out of the opening.

It is particularly preferably provided that the multiplicity of hooks are arranged on the presentation body and the plurality of openings are arranged on the base plate. The hook or hooks are preferably in one piece with the presentation body. The resilient limb portion or portions is or are preferably provided in one piece with the base body.

Preferably there are as many openings as there are hooks. It will be noted however that this is not absolutely necessary. For example, for reasons of production engineering, it may be advantageous to manufacture base bodies with a fixed number of openings which are used with different presentation bodies which possibly have different numbers of hooks. In that case some of the openings possibly remain empty in the condition of clipping engagement, and therefore no hooks project into those openings.

Preferably all openings are provided with the above-described limb portion. It will be noted however that this is not absolutely necessary.

Destruction-free release of the clipping engagement is possible only with difficulty, if at all, in the case of the emblem carrier according to the invention.

It is particularly preferably provided that the head portion of the hook is pressed against the opening by the limb portion in the clipped condition. That provides for even better locking of the hook to the base plate. For that purpose it can also be provided that a side of the hook, that faces towards the limb portion, is provided with a roughened or stepped surface so that the canting between the limb portion and the hook is increased.

The hooks can be arranged for example at a peripheral edge and/or a central region of the presentation body.

The presentation body can comprise for example ABS, PMMA, PA, ASA or other plastic materials (preferably chromium-plated).

The base plate can comprise for example PMMA, ABS, PA, ASA or other plastic materials. Alternatively or additionally apertures for receiving screws or the like can be provided in the base plate.

The base plate can be provided at its rear side with an adhesive layer for fixing to a supporting surface.

The emblem carrier can be provided and designed for fixing to the bodywork, for example the engine hood, of a motor vehicle, or other parts of a motor vehicle.

Protection is also claimed for the use of an emblem carrier in accordance with at least one of the above-discussed embodiments for the arrangement of an emblem on a motor vehicle, preferably on the bodywork of a motor vehicle.

Further advantages and details of the invention will be apparent from the Figures and the related specific description. In the Figures:

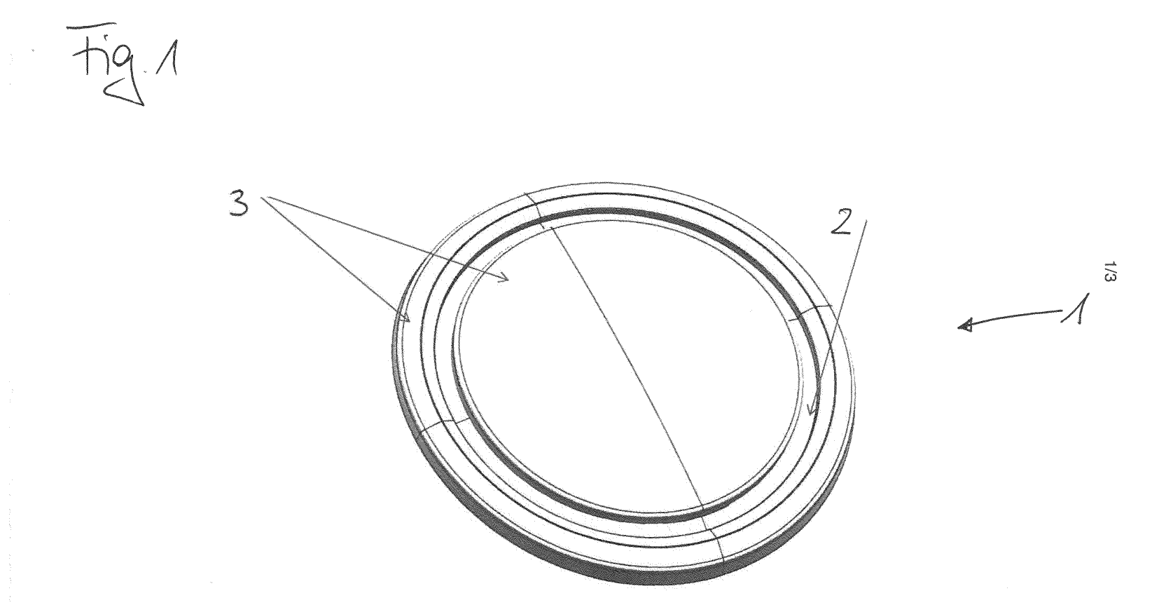

FIG. 1 shows a perspective view of an embodiment of an emblem carrier according to the invention,

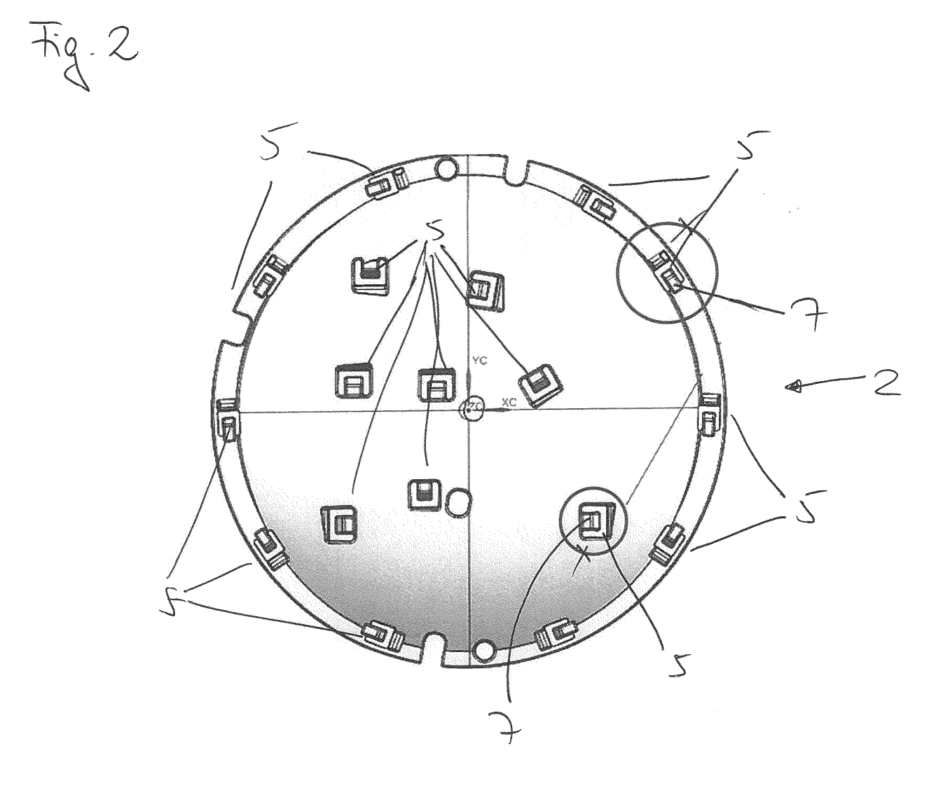

FIG. 2 shows a plan view of the base plate, and

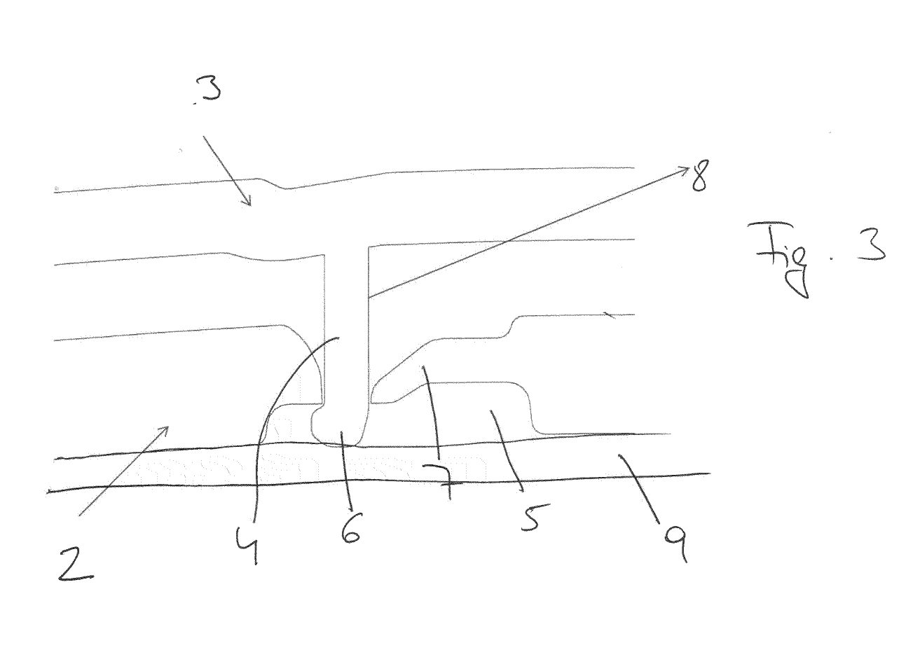

FIG. 3 shows a detail view illustrating a region of the emblem carrier of FIG. 1, wherein the presentation body and the base plate are in the condition of clipping engagement.

FIG. 1 shows an emblem carrier 1 with a presentation body 3 which here is shown blank but which can be in the form of an emblem (for example as a trade mark) or can carry an emblem.

The presentation body 3 is to be clipped to a base plate 2 which in this embodiment carries an adhesive layer 9. The emblem carrier 1 can be fixed to a suitable supporting surface by way of the adhesive layer 9.

FIG. 2 shows the base plate 2 provided with a plurality of openings 5. Some of the openings 5 are arranged at a peripheral edge of the base plate 2 and can receive hooks 4 correspondingly arranged at the peripheral edge of the presentation body 3. Another part of the openings 5 can be arranged on a central region of the base plate 2 and can receive hooks 4 correspondingly arranged at a central region of the presentation body 3.

FIG. 3 representatively shows one of the openings 5 which are arranged in the base plate 2. A resilient limb portion 7 which is of a tongue-shaped configuration projects into the opening 5 and partially covers it. Upon introduction of the hook 4 arranged on the presentation body 3 the head portion 6 thereof pushes the limb portion 7 somewhat out of the way in the direction of the rear side of the base plate, which is possible by virtue of the resilient nature of the limb portion 7. When the head portion 6 has engaged behind the base plate 2 and therefore the condition of clipping engagement has been implemented the limb portion 7 moves back into its starting position, although not entirely in this embodiment, but presses the head portion 6 of the hook 4 somewhat against the base plate 2.

1. An emblem carrier comprising:
a base plate by way of which the emblem carrier can be fixed to a supporting surface, and
a presentation body which is in the form of an emblem or which serves for the arrangement of an emblem,
wherein the presentation body and the base plate are fixed together by a clipping engagement, which has a multiplicity of hooks and a plurality of openings, wherein in the clipped condition a hook projects into an opening and a head portion of said hook engages behind the opening,
wherein there is provided a resilient limb portion which partially covers the opening and which moves out of the way of the head portion of the hook when the hook is introduced into the opening.

2. An emblem carrier as set forth in claim 1, wherein the multiplicity of hooks are arranged on the presentation body and the plurality of openings are arranged on the base plate.

3. An emblem carrier as set forth in claim 1, wherein the head portion of the hook is pressed against the opening by the limb portion in the clipped condition.

4. An emblem carrier as set forth in claim 3, wherein a side of the hook, that faces towards the limb portion, is provided with a roughened or stepped surface.

5. An emblem carrier as set forth in claim 1, wherein at least one of the hooks is arranged at a peripheral edge of the presentation body.

6. An emblem carrier as set forth in claim 1, wherein at least one of the hooks is arranged at a central region of the presentation body.

7. An emblem carrier as set forth in claim 1, wherein the base plate is provided with an adhesive layer.

8. An emblem carrier as set forth in claim 1, wherein apertures for receiving screws or the like are provided on the base plate.

9. Use of an emblem carrier as set forth in claim 1 for the arrangement of an emblem on a motor vehicle, preferably on the bodywork of a motor vehicle.
